(19) United States
(12) Patent Application Publication
(10) Pub. No.: US 2008/0142761 A1
(43) Pub. Date: Jun. 19, 2008

(54) OPTICALLY TRANSPARENT, XRAY-OPAQUE COMPOSITION, METHODS OF MANUFACTURE THEREOF AND ARTICLES COMPRISING THE SAME

(75) Inventors: Sanjay Gurabasappa Charati, Bangalore Karnataka (IN); Soumyadeb Ghosh, Kundanhalli Bangalore (IN); Gautam Madan, Ithaca, NY (US)

Correspondence Address: CANTOR COLBURN, LLP, 20 Church Street, 22nd Floor, Hartford, CT, 06103, US

(73) Assignee: General Electric Company, Schenectady, NY (US)

(21) Appl. No.: 11/612,774

(22) Filed: Dec. 19, 2006

(51) Int. Cl. G21F 1/10

(52) U.S. Cl. 252/478

(57) ABSTRACT

Disclosed herein is a composition comprising an organic polymer composition that comprises an organic polymer that has a refractive index of about 1.60 to about 1.66; and an xray absorbing filler composition that comprises barium sulfate that has been annealed to a temperature of about 500 to about 1,500° C. Disclosed herein too is a method for manufacturing a composition comprising annealing barium sulfate to a temperature of about 500 to about 1,500° C. to form annealed barium sulfate; and blending an organic polymer composition with the annealed barium sulfate; wherein the organic polymer composition comprises an organic polymer that has a refractive index of about 1.60 to about 1.66.

### BACKGROUND

This disclosure relates to optically transparent, xray-opaque compositions, methods of manufacture thereof and articles comprising the same.

Lead filled glass is currently used to attenuate or shield living beings from harmful radiation such as xrays. Lead is toxic as well as heavy in weight. Consequently lead filled glass is also heavy. It is therefore desirable to have a composition that is xray opaque and light in weight. It is also desirable to have a composition that can be easily processed and that can be effectively and easily molded into various desired shapes upon demand.

### SUMMARY

Disclosed herein is a composition comprising an organic polymer composition that comprises an organic polymer that has a refractive index of about 1.60 to about 1.66; and an xray absorbing filler composition that comprises barium sulfate that has been annealed to a temperature of about 500 to about 1,500° C.

Disclosed herein is a composition comprising an organic polymer composition that comprises an organic polymer; and an xray absorbing filler composition that comprises barium sulfate; wherein the composition has transparency of greater than or equal to about 80%, a haze of less than or equal to about 40% and an xray absorption capability of greater than or equal to about 5% of incident radiation when measured on a sample having a cross-sectional thickness of 2 millimeters.

Disclosed herein too is a method for manufacturing a composition comprising annealing barium sulfate to a temperature of about 500 to about 1,500° C. to form annealed barium sulfate; and blending an organic polymer composition with the annealed barium sulfate; wherein the organic polymer composition comprises an organic polymer that has a refractive index of about 1.60 to about 1.66.

Disclosed herein too is an article comprising a composition having a transparency of greater than or equal to about 80%, a haze of less than or equal to about 40% and an xray absorption capability of greater than or equal to about 5% of incident radiation when measured on a sample having a cross-sectional thickness of 2 millimeters; wherein the composition is manufactured by blending an organic polymer composition that comprise an organic polymer with an xray absorbing filler composition that comprises barium sulfate; wherein the barium sulfate has been annealed to a temperature of about 500 to about 1,500° C. prior to the blending.

### DETAILED DESCRIPTION OF FIGURES

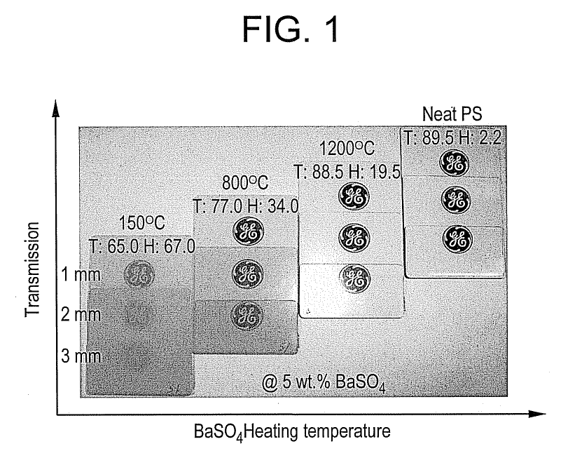

FIG. 1 is a pictorial-graphical representation of samples containing barium sulfate that has been annealed to different temperatures;

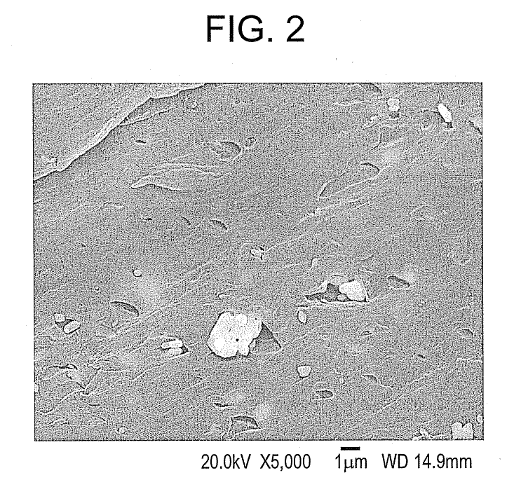

FIG. 2 is a scanning electron micrograph of a composition that contains barium sulfate that has been annealed to 150° C.; and

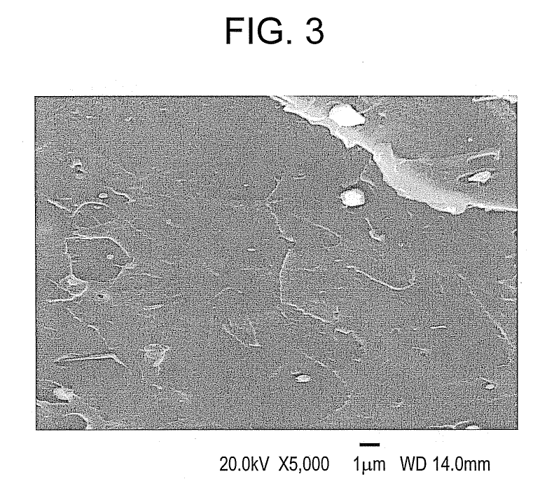

FIG. 3 is a scanning electron micrograph of a composition that contains barium sulfate that has been annealed to 800° C.

### DETAILED DESCRIPTION

The use of the terms “a” and “an” and “the” and similar references in the context of describing the invention (especially in the context of the following claims) are to be construed to cover both the singular and the plural, unless otherwise indicated herein or clearly contradicted by context. The modifier “about” used in connection with a quantity is inclusive of the stated value and has the meaning dictated by the context (e.g., it includes the degree of error associated with measurement of the particular quantity). All ranges disclosed herein are inclusive of the endpoints, and the endpoints are independently combinable with each other.

Disclosed herein is a composition that comprises an organic polymer composition and a xray absorbing filler composition. In one embodiment, the composition comprises the xray absorbing filler composition in amounts that render the composition optically transparent (e.g., having an optical transparency greater than or equal to about 90%) while attenuating xrays that are incident upon the composition. In another embodiment, the composition comprises the xray absorbing filler composition in amounts that render the composition partially optically transparent (e.g., having an optical transparency of about 50% to about 90%) while attenuating xrays that are incident upon the composition. The composition advantageously matches the refractive index of the xray absorbing filler composition with the refractive index of the polymer. The composition is light weight, lead free, and can easily be molded into desired shapes for providing protection from xrays.

In one embodiment, in one manner of matching the refractive index of the xray absorbing filler composition with the refractive index of the polymer, the xray absorbing filler composition comprises barium sulfate (BaSO₄) that is annealed at an elevated temperature of about 500 to about 1,500° C. for a period of time of about 2 to about 300 minutes. Without being limited by theory, the annealing of the barium sulfate promotes a reduction of the amount of water present in the barium sulfate. The removal of water from the barium sulfate results in a reduced release of water into the organic polymer composition during the manufacturing of the composition. In one embodiment, as a result of the reduced level of water in the barium sulfate, fewer voids are produced in the composition, which improves the transparency of the composition.

As a result of the reduction in water present in the barium sulfate (due to the annealing), the refractive index of the barium sulfate particles is about 1.60 to about 1.66. Thus by choosing an organic polymer composition with a refractive index of about 1.60 to about 1.66 and blending it with the annealed barium sulfate, an optically transparent composition can be obtained.

The organic polymer composition generally comprises organic polymers having a refractive index of about 1.60 to about 1.66. In one embodiment, the organic polymer composition is optically transparent, i.e., it does not absorb substantial amounts of electromagnetic radiation between the wavelengths of 380 to 780 nanometers (nm). The organic polymer used in the compositions may be selected from a wide variety of thermoplastic polymers, thermosetting polymers, blends of thermoplastic polymers, or blends of thermoplastic polymers with thermosetting polymers. The organic polymer can comprise a homopolymer, a copolymer such as a star block copolymer, a graft copolymer, an alternating block copolymer or a random copolymer, ionomer, dendrimer, or a combination comprising at least one of the foregoing types of organic polymers. The organic polymer may also be a blend of polymers, copolymers, terpolymers, or the like, or a combination comprising at least one of the foregoing types of organic polymers.

In one embodiment, the organic polymer composition comprises a sulfur moiety. Examples of organic polymer compositions that comprise a sulfur moiety are polysulfones (1.6330), polyethersulfones, polysulfides, {poly[4,4′-isopropylidene diphenoxy di(4-phenylene)sulfone]} (1.6330), poly(2-vinylthiophene) (1.6376), poly(p-phenylene ether-sulfone) (1.6500), or the like, or a combination comprising at least one of the foregoing organic polymer compositions that comprise a sulfur moiety. The numbers in the parenthesis indicate the refractive index and are provided where available.

In another embodiment, other organic polymers with refractive indices between about 1.60 to about 1.66 can be used in the composition. Examples of other suitable organic polymers with refractive indices between about 1.60 to about 1.66 are polycarbonate copolymers, poly(alpha-naphthyl carbinyl methacrylate) (1.6300), polyetherimide (1.630), poly(phenyl methyl silane) (1.6300), polyimides (1.64 to 1.67), poly(2,6-diphenyl-1,4-phenylene oxide) (1.6400), poly(alpha-naphthyl methacrylate) (1.6410), or the like, or a combination comprising at least one of the foregoing polymers. The numbers in parenthesis show the refractive index of the corresponding organic polymer and are provided where available.

Exemplary organic polymers are polysulfones, polyethersulfones or polycarbonate copolymers.

It is generally desirable for the refractive index of the organic polymer composition to be as close as possible to the refractive index of the xray absorbing filler composition. In one embodiment, the refractive index of the organic polymer composition is equal to the refractive index of the xray absorbing filler composition. In one embodiment the organic polymer composition has a refractive index within about 10% of the refractive index of the xray absorbing filler composition, more specifically within about 5% of the refractive index of the xray absorbing filler composition, and more specifically within about 2% of the refractive index of the xray absorbing filler composition. The organic polymers are generally present in an amount of about 40 to about 98 wt %, specifically 50 to 90 wt %, and more specifically about 55 to about 85 wt % of the total weight of the organic polymer composition.

The xray absorbing filler composition generally comprises barium sulfate (BaSO₄). Barium sulfate is a white crystalline solid that has a refractive index between about 1.60 to about 1.66. In an exemplary embodiment, the barium sulfate has a refractive index of about 1.64.

As detailed above, in order to obtain a refractive index for the barium sulfate that is similar to the refractive index for the organic polymer composition, it is desirable to anneal the barium sulfate to an elevated temperature of about 500 to about 1,500° C. for a period of time of about 2 to about 300 minutes. In one embodiment, it is desirable to anneal the barium sulfate to an elevated temperature of about 700 to about 1,200° C., specifically about 800 to about 1000° C.

The time period of annealing is dependent upon the mass of barium sulfate that is to be annealed. In one embodiment, it is desirable to anneal the barium sulfate for a period of time of about 5 to about 300 minutes, specifically about 8 to about 250 minutes, specifically about 10 to about 200 minutes. An exemplary annealing can be conducted by annealing the barium sulfate in a furnace at a temperature of about 1,200° C. for about 10 minutes, followed by cooling.

Following annealing, the barium sulfate is ground to generate particles of barium sulfate. Following the grinding the particles of barium sulfate can be sieved to collect particles having a certain particle size. The grinding can be conducted in a ball mill, roll mill, Waring blender, Henschel mixer, or the like. The grinding can be conducted either in the dry state or the wet state. If the grinding is conducted in the wet state, the barium sulfate particles may be subjected to drying after the grinding operation.

In one embodiment, it is desirable to use barium sulfate particles having an average particle size of about 1 to about 1,000 micrometers, specifically about 10 to about 800 micrometers, more specifically about 20 to about 700 micrometers. An exemplary particle size is about 60 micrometers.

The barium sulfate is added in amounts of about 2 to about 60 wt %, specifically about 3 to about 40 wt %, more specifically about 10 to about 30 wt %, and even more specifically about 5 to about 25 wt % of the total weight of the composition.

The xray absorbing filler composition may further optionally comprise small amounts of other secondary xray absorbing fillers. Examples of such fillers are metal particles of lead, barium, tungsten, bismuth, or the like, particles of barium sulfate, bismuth trioxide, bismuth oxychloride, bismuth sub-carbonate, or the like, or a combination comprising at least one of the foregoing non-metal particles.

The secondary xray absorbing fillers are generally present in amounts of up to 2 wt %, specifically less than or equal to about 1.5 wt %, more specifically less than or equal to about 1 wt %, and even more specifically less than or equal to about 0.5 wt % of the total weight of the composition.

Other additives such as mold release agents, anti-ozonants, anti-oxidants, impact modifiers, antistatic agents, pigments, dyes, lubricants, anti-microbials, flame retardants, visual effect additives, fibers such as carbon fibers, glass fibers, carbon nanotubes, or the like; antistatic agents, plasticizers, fillers such as fumed silica, aerogels, carbon black, or the like, or a combination comprising at least one of the foregoing additives may be added to the composition if desired.

In one embodiment, in one manner of proceeding, the organic polymer composition and xray absorbing filler composition may be blended to form the composition. The blending can include dry blending, melt blending, solution blending or a combination comprising at least one of the foregoing forms of blending.

Melt blending of the composition involves the use of shear force, extensional force, compressive force, ultrasonic energy, electromagnetic energy, thermal energy or combinations comprising at least one of the foregoing forces or forms of energy and is conducted in processing equipment wherein the aforementioned forces are exerted by a single screw, multiple screws, intermeshing co-rotating or counter rotating screws, non-intermeshing co-rotating or counter rotating screws, reciprocating screws, screws with pins, barrels with pins, rolls, rams, helical rotors, or combinations comprising at least one of the foregoing.

Melt blending involving the aforementioned forces may be conducted in machines such as single or multiple screw extruders, Buss kneader, Henschel, helicones, Ross mixer, Banbury, roll mills, molding machines such as injection molding machines, vacuum forming machines, blow molding machine, or then like, or combinations comprising at least one of the foregoing machines.

In one embodiment, the organic polymer composition and xray absorbing filler composition are subjected to dry blending prior to melt blending. The dry blending may be conducted in a Henschel mixer while the melt blending may be conducted in an extruder.

In another embodiment, the organic polymer composition and xray absorbing filler composition are fed into the throat of an extruder. In yet another embodiment, the organic polymer composition is fed into the throat of the extruder, while the xray absorbing filler composition is fed into the extruder downstream of the throat. In yet another embodiment, the organic polymer composition and a first portion of the xray absorbing filler composition are fed into the throat of an extruder, while a second portion of the xray absorbing filler composition is fed into the extruder downstream of the throat. In yet another embodiment, the xray absorbing filler composition can be added to the extruder in the form of a masterbatch.

The extrudate from the extruder is cooled and pelletized. The pellets may be subjected to molding in an injection-molding machine if desired to create articles having various sizes or shapes. Exemplary articles are sheets, films, slabs, or the like.

The composition can have a transparency and a haze that are dependent upon the amount of the xray absorbing filler composition. In one embodiment, the composition can have a transparency of about 2 to about 98% for a sample having a cross-sectional thickness of about 2 millimeters when measured according to ASTM D 1003. In an exemplary embodiment, the composition can have a transparency greater than or equal to about 50%, specifically greater than or equal to about 65%, more specifically greater than or equal to about 80%, and even more specifically greater than or equal to about 95% for a sample having a cross-sectional thickness of about 2 millimeters when measured according to ASTM D 1003.

The composition can have a haze of about 2 to about 98% for a sample having a cross-sectional thickness of 2 millimeters when measured according to ASTM D 1003. In an exemplary embodiment, the composition can have a haze of greater than or equal to about 65%, specifically greater than or equal to about 75%, more specifically greater than or equal to about 85% and more specifically greater than or equal to about 95% for a sample having a cross-sectional thickness of 2 millimeters when measured according to ASTM D 1003.

In another exemplary embodiment, the composition has a haze of less than or equal to about 20%, specifically less than or equal to about 15%, more specifically less than or equal to about 10%, and even more specifically less than or equal to about 5% for a section having a cross-sectional thickness of 2 millimeters when measured according to ASTM D 1003.

The composition can attenuate x-radiation in an amount of greater than or equal to about 5%, specifically greater than or equal to about 10%, more specifically greater than or equal to about 15%, and even more specifically greater than or equal to about 25%, when a sample having a cross-sectional thickness of about 3 millimeters is subjected to x-radiation. The percentage attenuation listed above is compared with the x-radiation emanating from the original source.

The following examples, which are meant to be exemplary, not limiting, illustrate compositions and methods of manufacturing of some of the various embodiments described herein.

### EXAMPLES

### Example 1

This example was conducted to demonstrate the capability of the composition to be transparent as well to absorb x-radiation. A composition comprising polysulfone and barium sulfate was blended together in an extruder and injection molded into sheets having thicknesses of either 1, 2 or 3 mm.

The polysulfone was purchased under the trade name ULTRASON® (grade S2010) from BASF in Germany and was added in an amount of 95 wt %, while the barium sulfate was purchased from Aldrich Chemicals in the USA and was added in an amount of 5 wt %, where the respective weight percents are based on the weight of the composition.

The barium sulfate was annealed at three different temperatures. Samples of barium sulfate were annealed to 150° C., 800° C., 1,200° C. or 1500° C. for 10 minutes respectively, where temperature of the oven was ramped to the required temperature at a rate of 10° C. per minute. After being cooled to room temperature, the respective samples of barium sulfate were ball milled using zirconia cylindrical balls having a combination diameters in the range of 3 millimeters to 10 millimeters. The product from the ball mill was then sieved using a 60 micrometer sieve. The respective samples of barium sulfate were then added to the throat of an extruder along with the polysulfone and extruded. The extruder had 6 barrels set at temperatures of 320° C., 330° C., 340° C., 345° C., 345° C., and 350° C. respectively, wherein the aforementioned temperatures are expressed sequentially in order from the throat of the extruder to the die. The die temperature was set at 355° C. The extruder speed was set at 300 revolutions per minute (rpm). The length to diameter ratio of the screw was 24.

Following extrusion, the pellets were injection molded in an injection-molding machine (DEMAG®, 85 Ton) manufactured by Larson & Toubro Inc. The injection-molded sheets had a thickness of either 1, 2 or 3 millimeters. The barrel temperature of the injection molding machine was set in the range of 320° C. to 355° C. The mold temperature was set at 120° C. The results for the 2 millimeter samples are shown in the Table 1 while the results for the 1 millimeter samples are shown in the FIG. 1.

TABLE 1

| | Annealing | | | |
|---|---|---|---|---|
| | Temperature | | | |
| Sample # | (° C.) | Transparency(%) | Haze(%) | Clarity (%) |
| 1 | Un-annealed | 88.9 | 3.8 | 98.4 |
| | Un-filled | | | |
| | polysulfone | | | |
| 2 | 150 | 51.1 | 86.2 | 88.2 |
| 3 | 800 | 68 | 52.1 | 79.5 |
| 4 | 1200 | 87.2 | 26 | 59 |
| 5 | 1500 | 85.4 | 16.5 | 77.7 |

Table 1 shows the transparency of the un-annealed sample of polysulfone that does not contain any barium sulfate. From the Table 1, it may be seen that the samples containing the barium sulfate annealed at temperatures of 1,200 and 1,500° C. have a transparency greater than or equal to 85% respectively. These samples also display a haze of less than or equal to 30%. From the Table 1, it may also be seen that the samples containing the barium sulfate annealed to 150° C. and 800° C. have transparencies of less than 70 % and a haze of greater than or equal to 50%. The results from Table 1 clearly indicate that as the barium sulfate is annealed to higher temperatures, the composition has increased transparency and reduced haze.

FIG. 1 shows the transparency of the compositions containing the barium sulfate annealed to 150° C., 800° C. and 1200° C. respectively. The compositions are molded into sheets having a thickness of 1 millimeter. The FIG. 1 also shows the transparency of a sample of polysulfone that does not contain any barium sulfate. From the FIG. 1, it may be seen that the sheet containing the barium sulfate annealed to 150° C. is less transparent than the sheet containing the barium sulfate annealed to 800° C. or 1,200° C. The sheet annealed to 1,200° C. is optically transparent. The 1 mm thick sheet containing the barium sulfate annealed to 150° C. has a transparency of 65% and a haze of 67%, while the 1 mm thick sheet containing the barium sulfate annealed to 800° C. has a transparency of 77% and a haze of 34% and the 1 mm thick sheet containing the barium sulfate annealed to 1,200° C. has a transparency of 88.5% and a haze of 19.5%.

FIGS. 2 and 3 are scanning electron micrographs for the sheets that contain the barium sulfate annealed to 150° C. and the barium sulfate annealed to 800° C. respectively. From the micrographs, it may be seen that the compositions contain a large number of voids. The annealing may cause sintering of the barium sulfate promoting a reduction of the pore volume in barium sulfate. This possibly results in a reduced release of trapped air or moisture into the organic polymer composition during the manufacturing of the composition. This produces fewer voids in the composition and therefore improves the transparency. Reduction of pore volume may also promote better refractive index matching between the annealed barium sulfate and the organic polymer composition thus improving the transparency of the composition.

### Example 2

This example was conducted to demonstrate the effect of a large amount of barium sulfate on the transparency of the composition. The barium sulfate was annealed at a temperature of 1,200° C. for 10 minutes. The sample had a thickness of 1 millimeter and was manufactured in a manner similar to the samples of the Example 1. Table 2 shows the properties of the composition containing 55 wt % barium sulfate.

TABLE 2

| BaSO₄ loading | Transparency(%) | Haze(%) | Clarity (%) |
|---|---|---|---|
| 55 wt % | 48 | 99.8 | 2.2 |

Comparing the results from the Table 1 above with those from the Table 2, it may be seen that by increasing the barium sulfate loading to 55 wt %, the transparency is reduced from above 85% to below 50%. The haze is also increased over the samples in the Table 1. However, it is noteworthy that even at a high filler loading of 55 wt %, the composition maintains a moderate level of transparency. The composition can therefore advantageously be used in applications such as a frosted glass. Apart from the xray attenuation, the composition also has a high specific gravity (of about 2), and hence may be used as a translucent, high specific gravity plastic.

### Example 3

This example was conducted to demonstrate the effect of the amount of barium sulfate on the ability of the composition to attenuate or to absorb xrays. The samples were manufactured as described in the Example 1. The sheets had a thickness of 2 millimeters. The incident x-radiation had an intensity produced at voltages of 70 kilovolts (KV), 110 KV and 150 KV respectively.

The results for the 2 millimeter thick sheet are shown in the Table 3.

TABLE 3

| | | Attenuation of X-rays | | |
|---|---|---|---|---|
| Sample # | BaSO₄ loading | 150 KV | 110 KV | 70 KV |
| 1 | 0 wt % | 0.8% | 1.9% | 2.8% |
| 2 | 5 wt % | 2.4% | 3.7% | 5.0% |
| 3 | 10 wt % | 4.2% | 5.8% | 9.5% |

From the Table 3, it may be seen that for the 2 millimeter sheets, as the filler loading is increased to 10 wt %, the attenuation increases to 9.5 % at 70 KV.

Thus from the above examples, it may be seen that by using the x-ray absorbing filler composition has a transparency of greater than or equal to about 85%, a haze of less than or equal to about 20% and an xray absorption capability of greater than or equal to about 5%, depending upon the amount of the filler composition used. This level of xray attenuation may be useful to produce plastic parts that are xray imageable.

When the amount of filler is greater than or equal to about 50%, the composition has transparency of less than or equal to about 85%, a haze of greater than or equal to about 50% and an xray absorption capability of greater than or equal to about 25%.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A composition comprising:
an organic polymer composition that comprises an organic polymer that has a refractive index of about 1.60 to about 1.66; and
an xray absorbing filler composition that comprises barium sulfate that has been annealed to a temperature of about 500 to about 1,500° C.

2. The composition of claim 1, wherein the organic polymer is poly(alpha-naphthyl carbinyl methacrylate), polyetherimide, poly(phenyl methyl silane), poly[4,4′-isopropylidene diphenoxy di(4-phenylene)sulfone], poly(sulfone), poly(2-vinylthiophene), polyimide, poly(2,6-diphenyl-1,4-phenylene oxide), poly(alpha-naphthyl methacrylate), poly(p-phenylene ether-sulfone), polycarbonate copolymers, or a combination comprising at least one of the foregoing organic polymers.

3. The composition of claim 1, wherein the refractive index of the organic polymer composition is substantially equal to the refractive index of the xray absorbing filler composition.

4. The composition of claim 1, wherein the organic polymer composition has a refractive index that is different from the refractive index of the xray absorbing filler composition; and wherein the difference between the refractive index of the polymer composition and the refractive index of the xray absorbing filler composition is less than 20%.

5. The composition of claim 1, wherein the barium sulfate is annealed for about 2 to about 300 minutes.

6. The composition of claim 1, wherein the barium sulfate has an average particle size of about 1 to about 1,000 micrometers.

7. The composition of claim 1, wherein the barium sulfate is present in an amount of about 2 to about 60 wt % of the total weight of the composition.

8. The composition of claim 1, wherein the xray absorbing filler composition further comprises a secondary xray absorbing filler in an amount of up to 2 wt % based on the total weight of the composition.

9. The composition of claim 1, wherein the secondary xray absorbing filler is lead, barium, tungsten, bismuth, barium sulfate, bismuth trioxide, bismuth oxychloride, bismuth sub-carbonate, or a combination comprising at least one of the foregoing secondary xray absorbing fillers.

10. The composition of claim 1, having a transparency of greater than or equal to about 80%, a haze of less than or equal to about 40% and an xray absorption capability of greater than or equal to about 5% of incident radiation when measured on a sample having a cross-sectional thickness of 2 millimeters.

11. The composition of claim 1, having a transparency of less than or equal to about 45%, a haze of greater than or equal to about 50% and an xray absorption capability of greater than or equal to about 25% of incident radiation when measured on a sample having a cross-sectional thickness of 2 millimeters.

12. An article manufactured by the composition of claim 1.

13. A composition comprising:
an organic polymer composition that comprises an organic polymer; and
an xray absorbing filler composition that comprises barium sulfate; wherein the composition has transparency of greater than or equal to about 80%, a haze of less than or equal to about 40% and an xray absorption capability of greater than or equal to about 5% of incident radiation when measured on a sample having a cross-sectional thickness of 2 millimeters.

14. The composition of claim 13, wherein the barium sulfate is annealed to a temperature of about 500 to about 1,500° C.

15. The composition of claim 13, wherein the organic polymer is poly(alpha-naphthyl carbinyl methacrylate), polyetherimide, poly(phenyl methyl silane), poly[4,4′-isopropylidene diphenoxy di(4-phenylene)sulfone], poly(sulfone), poly(2-vinylthiophene), polyimide, poly(2,6-diphenyl-1,4-phenylene oxide), poly(alpha-naphthyl methacrylate), poly(p-phenylene ether-sulfone), polycarbonate copolymers, or a combination comprising at least one of the foregoing organic polymers.

16. The composition of claim 13, wherein the refractive index of the organic polymer composition is substantially equal to the refractive index of the xray absorbing filler composition.

17. The composition of claim 13, wherein the organic polymer composition has a refractive index that is different from of the refractive index of the xray absorbing filler composition; and wherein the difference between the refractive index of the polymer composition and the refractive index of the xray absorbing filler composition is less than 20%.

18. A method for manufacturing a composition comprising:
annealing barium sulfate to a temperature of about 500 to about 1,500° C. to form annealed barium sulfate; and
blending an organic polymer composition with the annealed barium sulfate; wherein the organic polymer composition comprises an organic polymer that has a refractive index of about 1.60 to about 1.66.

19. The method of claim 18, wherein the blending comprising melt blending.

20. The method of claim 18, further comprising grinding the barium sulfate to a size of about 1 to about 1,000 micrometers.

21. The method of claim 18, further comprising injection molding the composition.

22. An article manufactured by the method of claim 18.

23. An article comprising:
a composition having a transparency of greater than or equal to about 80%, a haze of less than or equal to about 40% and an xray absorption capability of greater than or equal to about 5% of incident radiation when measured on a sample having a cross-sectional thickness of 2 millimeters; wherein the composition is manufactured by blending an organic polymer composition that comprise an organic polymer with an xray absorbing filler composition that comprises barium sulfate; wherein the barium sulfate has been annealed to a temperature of about 500 to about 1,500° C. prior to the blending.
